(19) United States
(12) Patent Application Publication
(10) Pub. No.: US 2012/0011762 A1
(43) Pub. Date: Jan. 19, 2012

(54) Nanocomposite fishing hooks

(76) Inventor: Vernon Magazzu, Bonita, CA (US)

(21) Appl. No.: 12/804,105

(22) Filed: Jul. 14, 2010

(51) Int. Cl. A01K 83/00; A01K 83/06

(52) U.S. Cl. 43/43.16; 43/44.8

(57) ABSTRACT

The preferred embodiment of the disclosed fishing hook utilizes a self reinforced polymer, Tecamax Self Reinforced Polymer (SRP), to form the hook. In addition, the hook has a nanocomposite coating, utilizing Nanobyk 3600 or Nanobyk 3601 as the nanocomposite additive, that increases the rigidity and scratch resistance of the hook. The hook may also utilize Bykoplast-1000 for pigmentation to produce color variations. The eyelet located opposite the barbed end of the hook is rotated ninety (90) degrees from conventional hooks so it lays flush with a surface when the hook is placed flush on the surface. The hook also has additional build-up in certain strategic locations along the hook, including near the eyelet end of the hook, near the barbed end of the hook and at the beginning of the curve of the hook for added strength and also contains additional smaller barbs along the length of the hook.

### CROSS REFERENCE TO RELATED APPLICATIONS

This non-provisional patent application does not claim priority to any United States provisional patent application or any foreign patent applications.

### FIELD OF THE DISCLOSURE

The disclosures made herein relate generally to the fishing tackle and accessories industry. The invention discussed herein is in the general classification of fishing hooks.

### BACKGROUND

Fishing is a popular activity enjoyed by millions of individuals worldwide. It can be a recreational activity among families and friends. Fishing also can be done competitively and professionally. Many anglers attempt to catch the biggest and/or the most fish and will do almost anything to accomplish these objectives. Fishing has no geographical or cultural limits as it is practiced around the world. In addition to being a recreational and competitive activity, fishing is one of the largest food acquiring industries and has been around for centuries.

The basic items needed for fishing are a hook, a line and a sinker. However, most anglers have a variety of fishing rods, reels, line types, hooks, floats and artificial lures. Most of these items will be stored in the angler's tackle box. Unfortunately, many professional anglers and recreational fishermen become frustrated when they are unsuccessful using these conventional items to catch fish. The problem often is a simple one. If the fish can see the hook in the water, they become wary and are disinclined to approach the fishing hook.

Many anglers design or modify hooks and lures in the quest to outwit the fish. Creating a truly functional, stealth hook that meets the necessary requirements of durability is an ever evolving process.

Conventional multifunctional materials, such as fiber reinforced or filled liquid crystal polymers/composites, require a tradeoff between various physical and mechanical properties and costs to generate fishing hooks of appropriate size and durability.

However, combinations of self-reinforced polymers and properties derived at a nano scale provide an opportunity to circumvent these tradeoffs in manufacturing a fishing hook. The transition from microparticles to nanoparticles leads to a number of changes in physical properties.

One of the major changes includes the increase in ratio of surface area to volume. As the surface area of a particle increases, the portions of its constituent atoms at or near the surface increases exponentially, creating more sites for bonding, catalysis or reaction with surrounding materials and resulting in improved properties such as strength and/or chemical and/or heat resistance. Additionally, the fact that nanoparticles have dimensions below the critical wavelength of light can render them approximately transparent which permits fishing hooks including such nanoparticles to be more concealed when used in water.

There is a need in the art for an easy to use, durable, lightweight, environmentally friendly fishing hook that will be difficult for fish to locate and that can be used in a variety of fishing applications.

### SUMMARY OF THE DISCLOSURE

The preferred embodiment of the fishing hook utilizes a self reinforced polymer, Tecamax Self Reinforced Polymer (SRP), to form the hook. In addition, the preferred embodiment of the hook has a nanocomposite coating, utilizing Nanobyk 3600 or Nanobyk 3601 as the nanocomposite additive, that increases the rigidity and scratch resistance of the hook. In certain embodiments, the hook also utilizes Bykoplast-1000 for pigmentation to produce color variations. The eyelet located opposite the barbed end of the hook is rotated ninety (90) degrees from conventional hooks so it lays flat/flush with a surface when the hook is placed flat/flush on the surface. The hook also has additional build-up in certain strategic locations along the hook, including near the eyelet end of the hook, near the barbed end of the hook and at the beginning of the curve of the hook for added strength. The preferred embodiment contains additional smaller barbs along the length of the hook to assist in keeping the hook from slipping off of a fish once engaged.

Certain alternative embodiments utilize an eyelet on the hook which is oriented in the conventional manner, causing the bottom of the eyelet to contact the surface when the hook is placed flat/flush on the surface such that the hole in the center of the eyelet cannot be seen from an overhead view.

Under some applications, embodiments of the invention may provide a relatively easy to use fishing hook.

Under some applications, embodiments of the invention may provide a transparent or translucent fishing hook.

Under some applications, embodiments of the invention may provide a fishing hook that does not need to be reinforced.

Under some applications, embodiments of the invention may provide an inexpensive fishing hook.

Under some applications, embodiments of the invention may provide a durable fishing hook.

Under some applications, embodiments of the invention may provide a strong fishing hook.

Under some applications, embodiments of the invention may provide a fishing hook that is difficult for a fish to locate in the water.

Under some applications, embodiments of the invention may provide a fishing hook that is easily stored with other fishing equipment in a tackle box.

Under some applications, embodiments of the invention may provide a fishing hook that can be used for fresh water and salt water fishing.

Under some applications, embodiments of the invention may provide a fishing hook that is lightweight.

Under some applications, embodiments of the invention may provide a fishing hook that is colored with pigments to match a variety of water conditions.

Under some applications, embodiments of the invention may provide a fishing hook that is environmentally friendly.

Under some applications, embodiments of the invention may provide a fishing hook that is scratch resistant.

### BRIEF DESCRIPTION OF THE DRAWINGS

Some embodiments of apparatus of the present invention are now described, by way of example only, and with reference to the accompanying drawings, in which:

FIG. 1 depicts an overhead view of the preferred embodiment of the fishing hook with the nanocomposite coating applied.

FIG. 2 depicts an overhead view of the preferred embodiment of the fishing hook with internal body shown without the nanocomposite coating applied.

FIG. 3 depicts an alternative embodiment of the fishing hook with an alternative eyelet design.

### DETAILED DESCRIPTION OF THE DRAWINGS

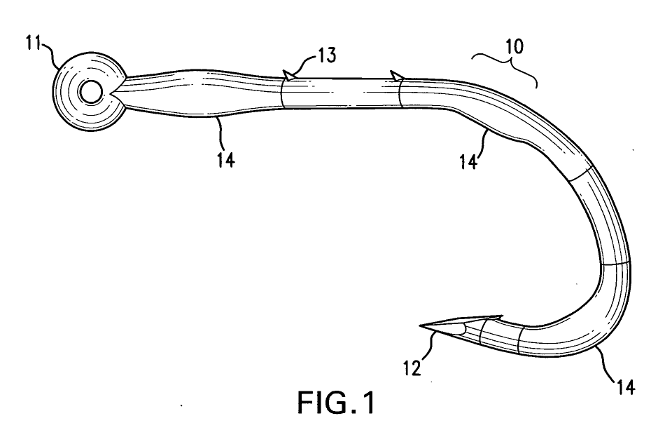

FIG. 1 depicts an overhead view of the preferred embodiment of the fishing hook with the nanocomposite coating applied. FIG. 1 shows a single curved fishing hook 10. The eyelet 11 of the fishing hook 10 can be attached to a line (not pictured) or lure (not pictured). The hook 10 has a barbed end 12 opposite the eyelet 11 for catching fish. The hook 10 is made of a self reinforced polymer, meaning it is not reinforced with any fibers (e.g. fiberglass, carbon and aramid), metal or other component and, as well known in the art, is strengthened by enhancing the properties of the polymeric phase itself via controlling the molecular orientation of the polymer chains. In certain embodiments, the hook may be translucent or of a variety of colors after a color additive is added.

The barbed end 12 of the hook 10 is formed with the same self reinforced polymer as used for the rest of the hook 10. Alternatively, the barbed end can be a steel or other similar insert that is attached to the hook 10.

The hook 10 has additional build up 14 at the end of the hook 10 approaching the eyelet 11 and the end of the hook 10 approaching the barbed end 12. Additional build-up 14 is also included at the beginning of the curve of the hook 10. The additional build-up causes the hook to not be of a uniform thickness throughout its length in this preferred embodiment.

Additional smaller barbs 13 are dispersed along the length of the hook 10 in this preferred embodiment to assist in securing the hook 10 in the mouth of a fish and preventing the hook 10 from sliding out of the mouth of a fish.

The eyelet 11 located opposite the barbed end 12 of the hook 10 is rotated ninety (90) degrees from conventional hooks so it lays flat/flush with a surface when the hook 10 is placed flat/flush on the surface. This creates added strength and durability for the hook 10. The hook can be designed to match a variety of water conditions (e.g. eutrophication, refraction, brackish or murky water).

The hook 10 is made of a self reinforced polymer that possesses the necessary strength for fishing applications. The hook 10 has the ability to be camouflaged through the addition of color additives for certain water conditions or through its translucent properties without the need for color additives in other water conditions.

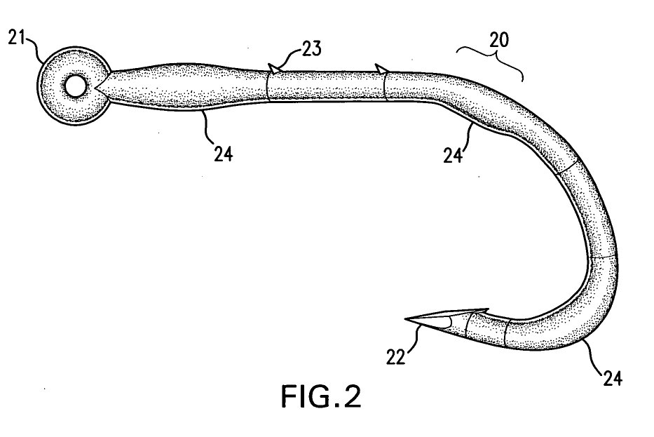

Because the hook 10 is made with a self reinforced polymer, the hook 10 does not need to be reinforced like other thermoplastic combinations used for fishing hooks. The self reinforced polymer of the preferred embodiment is described in greater detail in conjunction with FIG. 2.

The preferred embodiment depicted in FIG. 1 also contains a nanocomposite coating on the hook 10 to give the added scratch resistance to the hook 10. A nanocomposite material/additive can be a multiphase solid material where one of the phases has one, two or three dimensions of less than 100 nanometers (nm), or structures having nano-scale repeat distances between the different phases that make up the material. A nanocomposite coating is a resin containing a nanocomposite material/additive. The nanocomposite coating may create five to ten times the strength and scratch resistance for the hook as compared to traditional thermoplastic fishing hooks. The introduction of metal oxides and/or silicates as the nanocomposite additives gives the hook added scratch resistance.

Two nanocomposite additives with the trade name Nanobyk 3600 and Nanobyk 3601 contain thirty-seven (37) nanometer diameter nanodur aluminum oxide particles applied via vapor synthesis. When these additives are blended into resins at very low concentration levels, scratch resistance increases dramatically. In nanophase tests, particle loadings of one percent resulted in five or tenfold increases in scratch resistance over liquid crystal polymers with urethane coatings.

Nanobyk 3600 or Nanobyk 3601 can be combined with a resin and applied as a coating cured by ultraviolet (UV) light or through vapor synthesis. UV curing is a fast process that often allows a coating to be applied as a liquid that cures to a solid in a matter of seconds in the presence of UV light. In the preferred embodiment, Nanobyk 3600 or Nanobyk 3601 are added to cycloaliphatic resin for UV curing. Preferably, the Nanobyk 3601 or Nanobyk 3601 would be less than 10% by weight of the coating. Although the thickness of the coating may vary, 1.2 mils (1 mil=25.4 microns) to 1.5 mils are often sufficient as a coating on the hook.

Physical vapor synthesis involves arc energy being applied to a solid precursor (e.g. metal) in order to generate a vapor at high temperature. A reactant gas is then added to the vapor and then cooled at a controlled rate to permit condensing to form nanoparticles. This method typically produces particles with an average size of 8 nm to 75 nm. Nanobyk has a hardness on the hardness ratio index of nine (9) out of a possible ten (10). The scratch and abrasion fighting ability of the Nanobyk permits the hook 10 to behave in a similar manner to a steel hook.

The self reinforced polymer and nanocomposite coating used to construct the hook 10 permit the hook 10 to be used in both saltwater and fresh water applications and create an environmentally friendly hook 10. Decomposing hooks comprised of nickel, chromium and a variety of toxic metals create threats to the environment while the self reinforced polymer and nanocomposite hooks described herein are far more environmentally friendly and do not add toxic metals to the water.

FIG. 2 depicts an overhead view of the preferred embodiment of the fishing hook with internal body shown without the nanocomposite coating applied. In the preferred embodiment shown in FIG. 2, the hook 20 is formed with a self reinforced polymer, Tecamax Self Reinforced Polymer (SRP), which is a relatively new polymer that is not a liquid crystal polymer. Tecamax SRP allows for a translucent appearance as opposed to the opaque appearance given by liquid crystal polymers. The Tecamax SRP is sufficiently strong that it does not need to be reinforced with fibers. The Tecamax SRP permits homogeneous molded parts to the fishing hook 20 rather than the fibrillar structure of liquid crystal polymer designs.

The Tecamax SRP used for the hook 20 is a highly aromatic resin derived from plentiful and inexpensive chlorobenzene. It is based on a string of substituted and unsubstituted phenylene rings that produce a highly rigid structure even at low temperatures. The Tecamax SRP (polyparaphenyl based on Paramax SRP) also has high pressure resistance, outstanding chemical resistance and stability and is of low weight and high scratch resistance.

FIG. 2 also shows an eyelet 21 of the fishing hook 20 that can be attached to a line (not pictured) or lure (not pictured). The hook 20 has a barbed end 22 opposite the eyelet 21 for catching fish. The hook 20 also contains additional build-up 24 at the end of the hook 20 approaching the eyelet 21 and the end of the hook 20 approaching the barbed end 22. Additional build-up 24 is also included at the beginning of the curve of the hook 20. Additional smaller barbs 23 are also dispersed along the length of the hook 20

Although the preferred embodiment of the hook utilizes Tecamax SRP, other self reinforcing polymers may also be used. Alternatively, a liquid crystal polymer and self reinforced polymer blend may be utilized. For example, a polysufone-Tecamax blend or a Peek-Ultem-Tecamax blend can be used for the fishing hook. These blends would still have the ability to have nanocomposite coatings applied.

Polysufone and Peek-Ultem (a combination of polyetherketone and polyetherimide) are liquid crystal polymers and can be combined with self reinforced polymers such as Tecamax. Although the ratio of liquid crystal polymer to self reinforced polymer may vary, a 70% by weight liquid crystal polymer and 30% by weight self reinforced polymer can be utilized in one preferred embodiment. In another preferred embodiment, one part by weight self reinforced polymer and two parts by weight liquid crystal polymer can be utilized. In general, any blend which includes a self reinforced polymer in the amount of 30% by weight or greater will suffice for fishing applications.

Color specks or particles could be included throughout the hook. This is normally done through a wetting and dispersing of additives because this permits a good dispersion of pigments. In this preferred embodiment, bykpolast-1000 (a combination of anionic and amphoteric surfactants) is used in the hook 20. Typically, during the pigmentation process, all of the air and moisture at the pigment surface is replaced during wetting, then the pigment agglomerates are broken up through grinding, and then the pigment dispersion is stabilized to prevent uncontrolled formation of flocculates.

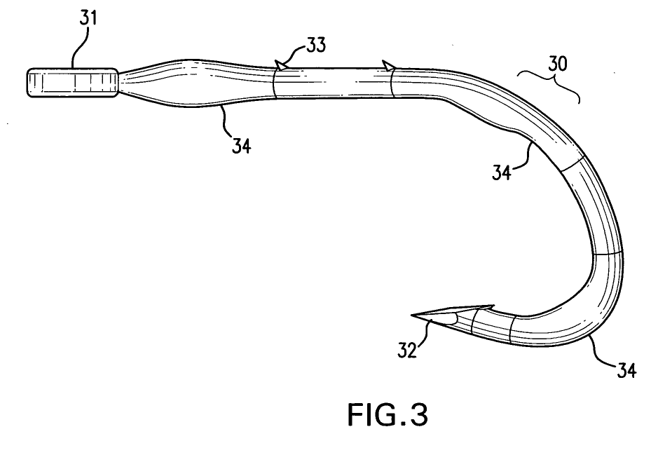

FIG. 3 depicts an alternative embodiment of the fishing hook with an alternative eyelet design. A single, curved fishing hook 30 is shown with a nanocomposite coating added. The eyelet 31 of the fishing hook 30 can be attached to a line (not pictured) or lure (not pictured). The hook 30 has a barbed end 32 opposite the eyelet 31 for catching fish. The hook 30 is made of a self reinforced polymer and may be translucent or contain color pigments. The hook 30 also contains additional build up 34 at the end of the hook 30 approaching the eyelet 31 and the end of the hook 30 approaching the barbed end 32. Additional build-up 34 is also included at the beginning of the curve of the hook 30. Additional smaller barbs 33 are dispersed along the length of the hook 30.

The eyelet 31 is oriented such that the bottom of the eyelet 31 contacts the surface when the hook 30 is placed flat/flush on the surface as shown in FIG. 3.

The fishing hooks of the disclosed embodiments operate in the same manner as traditional fishing hooks. They can be attached to a line and baited and/or attached to a lure. A lure could be attached to the hook using a standard ring that attaches to the eyelet. The lure entices fish to approach the fishing hook, increasing the chances the fish come into contact with the barbed end of the fishing hook.

Due to their translucency or colored pigmentation to match the water, the described hooks are more difficult for a fish to identify. Consequently, fish are more likely to approach the hook and become impaled on the barbed end or ends of the hook.

The size of the fishing hooks of the disclosed embodiments may vary widely. They can be made in all standard fishing hook sizes.

It will be recognized by those skilled in the art that changes or modifications may be made to the above-described embodiments without departing from the broad inventive concepts of the invention. It should therefore be understood that this invention is not limited to the particular embodiments described herein, but is intended to include all changes and modifications that are within the scope and spirit of the invention as set forth in the claims.

What is claimed is:

1. A fishing device comprising:
(a) a hook made of a self reinforced polymer;
(b) a barbed end on the hook; and
(c) an eyelet on the hook opposite the barbed end.

2. The fishing device of claim 1 wherein the self reinforced polymer is polyparaphenyl.

3. The fishing device of claim 1 wherein a combination of anionic and amphoteric surfactants is used for pigmentation of the hook.

4. The fishing device of claim 1 further comprising a nanocomposite coating on the hook.

5. The fishing device of claim 4 wherein the nanocomposite coating includes a resin and at least one of a metal oxide and silicate as a nanocomposite additive.

6. The fishing device of claim 4 wherein the nanocomposite coating includes cycloaliphatic resin and nanodur aluminum oxide.

7. The fishing device of claim 4 wherein the nanocomposite coating includes greater than 90% by weight cycloaliphatic resin and less than 10% by weight thirty-seven nanometer diameter nanodur aluminum oxide.

8. The fishing device of claim 1 further comprising:
additional build-up in the hook approaching the barbed end, the eyelet and a curve in the hook.

9. The fishing device of claim 1 wherein the eyelet lays flat with a surface when the hook is placed flat on the surface.

10. The fishing device of claim 1 wherein the hook contains a plurality of small barbs along the length of the hook.

11. The fishing device of claim 1 wherein the bottom of the eyelet contacts a surface when the hook is placed flat on the surface.

12. A fishing device comprising:
(a) a hook made with a blend of a self reinforced polymer and a liquid crystal polymer;
(b) a barbed end on the hook; and
(c) an eyelet on the hook opposite the barbed end.

13. The device of claim 12 wherein the self reinforced polymer is polyparaphenyl and the liquid crystal polymer is polysufone.

14. The device of claim 13 wherein the hook is made of approximately seventy percent by weight of polysufone and approximately thirty percent by weight of polyparaphenyl.

15. The device of claim 12 wherein the self reinforced polymer is at least thirty percent by weight of the hook.

16. The device of claim 12 wherein the self reinforced polymer is polyparaphenyl and the liquid crystal polymer is a combination of polyetherketone and polyetherimide.

17. The device of claim 16 wherein the hook is made of approximately seventy percent by weight of the combination of polyetherketone and polyetherimide and approximately thirty percent by weight of polyparaphenyl.

18. A fishing device comprising:
(a) a hook made of a self reinforced polymer and having a nanocomposite coating;
(b) a barbed end on the hook;
(c) an eyelet on the hook opposite the barbed end wherein the eyelet lays flush with a surface when the hook is placed flat on the surface;
(d) additional build-up in the hook approaching the barbed end, the eyelet and a curve in the hook; and
(e) a plurality of barbs along the length of the hook.
